(19) United States
(12) Patent Application Publication
(10) Pub. No.: US 2018/0118045 A1
(43) Pub. Date: May 3, 2018

(54) Vehicle Charger Network

(71) Applicant: WiTricity Corporation, Watertown, MA (US)

(72) Inventors: Alexander Gruzen, Austin, TX (US); Mary S. Chan, Chatham, NJ (US)

(21) Appl. No.: 15/801,607

(22) Filed: Nov. 2, 2017

Related U.S. Application Data
(60) Provisional application No. 62/416,467, filed on Nov. 2, 2016.

(51) Int. Cl. B60L 11/18

(52) U.S. Cl. CPC B60L 11/1824; B60L 11/1846; B60L 11/1816; B60L 2240/622; B60L 11/1842; B60L 2230/16; B60L 2240/72; B60L 11/1848

(57) ABSTRACT

A computing device can receive first information indicative of an availability of multiple chargers and can receive a request for a list of available chargers from a vehicle operator. A hierarchical list of available chargers is created based on the first information and at least one operator preference, and information indicative of an operator selection of at least one charger from the hierarchical list is received by the computing device.

### CROSS-REFERENCE TO RELATED APPLICATIONS

This patent application claims priority to U.S. Provisional Patent Application No. 62/416,467 filed on Nov. 2, 2016, entitled, “Vehicle Charger Network”, the disclosure of which is incorporated herein, in its entirety, by reference.

### FIELD OF INVENTION

The application generally relates to electric vehicle charging systems and, more particularly, to a network of chargers for providing power to electric vehicles.

### BACKGROUND

At any given time, an individually owned vehicle charger may be available while a vehicle operator may be seeking a charger. For example, the vehicle charger may be located in the driveway or garage of a residence. This charger may only get used by the charger owner when the owner's vehicle is ready for charging (such as in the evenings after arriving from work or weekends). In the remainder of the time, the charger could be used to charge other vehicles.

### SUMMARY

Vehicle operators may be seeking a charger when they are away from their personal or usual chargers (such as at their workplaces). Autonomous vehicles may be seeking a charger when deployed in the field. Chargers can be connected to a service that allows for a vehicle to be charged by a charger not owned by the vehicle operator. Such a service could decrease “range anxiety” for vehicle operators seeking chargers away from their homes, at their workplaces, during travel, or in locations where commercial chargers are not available. Such a service could financially incentivize charger operators to make their chargers available to the public. Some challenges in bringing these entities together include, from the perspective of a vehicle operator, the ability to locate the charger and, from the perspective of a charger owner, a sense of security in providing personal property (the charger) for public use.

In a first aspect, a computer implemented method includes a computing device that can receive first information indicative of an availability of multiple chargers and receive a request from an operator of a vehicle for a list of available chargers. A hierarchical list of available chargers is created based on the first information and at least one operator preference. The hierarchical list is delivered to an operator interface. Second information indicative of an operator's selection of at least one charger from the hierarchical list is received.

In a second aspect, a computer program product is tangibly embodied in a machine-readable storage device. The computer program product includes instructions that are operable to cause a data processing apparatus to receive first information indicative of the availability of multiple chargers, receive a request from an operator of a vehicle for a list of available chargers, and create a hierarchical list of available chargers based on the first information and at least one operator preference. The hierarchical list is delivered to an operator interface. Second information indicative of an operator selection of at least one charger from the hierarchical list is received.

In a third aspect, a computer device, including a computer processor system, is configured to receive first information indicative of the availability of multiple chargers, receive a request from an operator of a vehicle for a list of available chargers, and create a hierarchical list of available chargers based on the first information and at least one operator preference. The hierarchical list is delivered to an operator interface. Second information indicative of an operator selection of at least one charger from the hierarchical list is received.

In some embodiments, the computer device receives third information indicative of a receiver of the vehicle positioned to receive power from the at least one charger. The computing device can signal to the at least one charger to initiate power transmission to the receiver. The computing device can transmit the third information to the at least one charger. The third information can include a receiver ID corresponding to the receiver of the vehicle. The receiver ID can be identifiable by the charger. The charger ID and receiver ID can be used in a handshake protocol between one of the at least one charger and the receiver. In some embodiments, the computing device receives fourth information indicative of an operator ceasing use of the charger, and determines a cost of charging based on characteristics of the charger and length of use of the charger.

In various embodiments, the computing device subtracts a first amount related to a cost of charging from an account of the operator of the vehicle and adds a second amount to an account of an operator of the charger. The second amount can be larger than the first amount. At least one of the first or second amounts can be a digital asset. In some embodiments, the computing device transmits a receipt that can include the cost for the charging session to the operator interface. The cost can be applied to an account of the operator.

Each charger can include a transmitter resonator configured to generate an oscillating magnetic field for capture by a receiver resonator of a wireless power receiver. A receiver of the vehicle can include a bidirectional resonator configured to transmit an oscillating magnetic field and capture an oscillating magnetic field.

In various embodiments, the operator interface can be an interface of a mobile device or a vehicle. In various embodiments, the at least one operator preference is at least one of a power level(s), a brand, an interoperability standard, a price range, a favorability rating, and a bidirectional functionality. The first information can be indicative of an availability and interoperability of multiple chargers.

A handshake protocol can be performed between the charger and the receiver. The handshake protocol can confirm that the vehicle receiver belongs to an account of the vehicle operator, and/or that the charger is the intended charger at the intended location for transmitting power to the receiver. The availability of multiple chargers can be indicative of at least one of the dates, times, and price that the charger is available. In some embodiments, the computer device can create a reservation based on the selection and the preference. The computer device can deliver the reservation to the operator interface. The operator of the vehicle can be a vehicle owner or an autonomous vehicle controller.

### BRIEF DESCRIPTION OF THE DRAWINGS

FIG. 1 shows a diagram of an exemplary embodiment of a scenario including a vehicle seeking a charger.

FIGS. 2A-2B show diagrams of exemplary embodiments of networks including a central server, charger operator, charger, vehicle operator, vehicle receiver, and the electric gird.

FIGS. 3A-3B show flowcharts of exemplary embodiments of connecting a vehicle receiver with a vehicle charger.

FIG. 4 shows a flowchart of an exemplary embodiment of controlling power transmission from a vehicle charger to a vehicle receiver.

FIG. 5 shows an exemplary computer that can perform at least part of the processing as related to the vehicle charged network.

### DESCRIPTION OF THE INVENTION

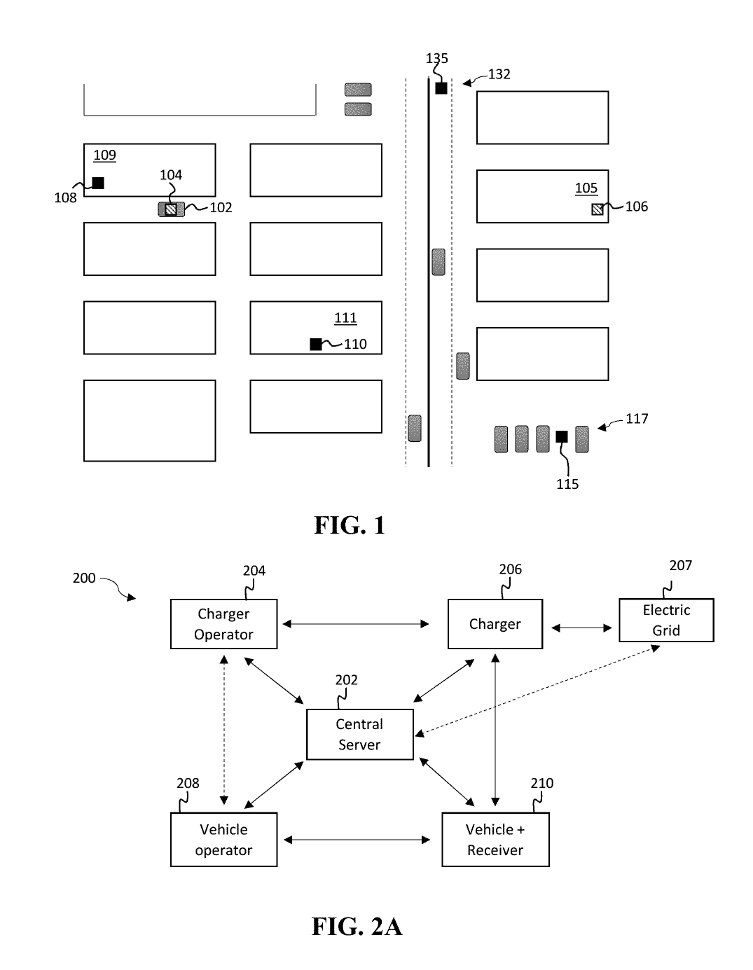

FIG. 1 shows a top-view diagram of an exemplary embodiment of wireless power transmitters (chargers) and wireless power receivers part of a network. Chargers may be at or in residences 105, 109, commercial buildings 111, public buildings, parking lots 117, garages, or the road 132. A vehicle 102 equipped with a wireless power receiver 104 may be away from its usual charger 106. For example, the usual charger 106 may be at a residence 105 belonging to the operator of the charger 106 and the vehicle 102. The vehicle 102 is traveling in a direction with at least one available charger 108 within, for example, a residential area. The available charger 108 may be at a residence 109. In some situations, there may be more than one available charger with which a vehicle could charge. For example, another available charger 110 may be at a commercial facility 111, or another available charger 115 may be at a parking lot 117. The decision between at least two chargers 108, 110, 115 can be determined when the vehicle operator initiates a search for a charger. With the charger determined, the vehicle can proceed to the charger.

In another example scenario, the receivers and chargers may be bidirectional, meaning the receiver on the vehicle can transfer power from the battery of the vehicle to the charger, and the charger can act as a receiver and deliver power to the grid 207. A vehicle 102 equipped with a wireless power receiver 104 may be away from its usual charger 106 and may have a battery with a full or nearly full state of charge. The decision between at least two bidirectional chargers 108, 110, 115 can be determined when the vehicle operator initiates a search for a bidirectional charger.

The term “vehicle” can refer to any motorized mobility means, such as a car, boat, plane, drone, motorcycle, helicopter, robot or underwater submarine. The vehicle can be for personal use, commercial use, cargo or passenger transport, or for surveillance. The vehicle can be an electric vehicle, a hybrid vehicle or another vehicle that includes a rechargeable battery or otherwise uses electric power. The “operator” of a vehicle can be a driver, user or controller, or in the case of an autonomous vehicle, a controller or software operating system. In embodiments, a vehicle operator can be a vehicle owner. In embodiments, “operator” of the charger can be an owner of the charger, a controller or software operating system, for example, the software operating system of a smart infrastructure, a smart grid, a utility, or a smart home system. “Chargers” can be wireless, plug-in, wired or conductive, or a combination of wired and wireless. “Receivers” can be wireless, plug-in, wired or conductive, or a combination of wired and wireless. For the avoidance of doubt, the methods and systems described herein can apply to wireless power chargers and receivers as well as wired charging systems that use a plug-in interface.

Examples of wireless power transfer systems are found in commonly owned U.S. patent application Ser. No. 12/613,686 published on May 6, 2010 as US 2010/0109445 and entitled “Wireless Energy Transfer Systems,” U.S. patent application Ser. No. 12/860,375 published on Dec. 9, 2010 as US 2010/0308939 and entitled “Integrated Resonator-Shield Structures,” U.S. patent application Ser. No. 13/222,915 published on Mar. 15, 2012 as US 2012/0062345 and entitled “Low Resistance Electrical Conductor,” U.S. patent application Ser. No. 13/283,811 published on Oct. 4, 2012 as US 2012/0248981 and entitled “Multi-Resonator Wireless Energy Transfer for Lighting,” the contents of which are incorporated by reference.

### Networks

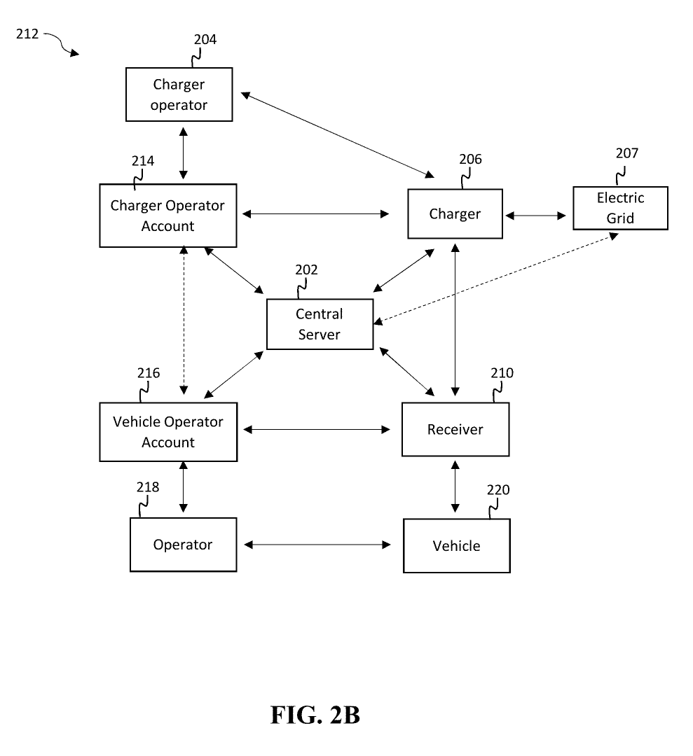

FIG. 2A shows a diagram of an exemplary embodiment of a network 200 for a service as described above. The service may include a central server 202 to process and control information exchange. In embodiments, the central server 202 may be connected to the charger 206 and receiver 210 hardware to ensure a successful charging event. The charger 206 and the receiver 210 can be bidirectional, and the charger 206 can be connected to the electric grid 207 or to a battery of the charger operator.

Each charger 206 can include a transmitter resonator configured to generate an oscillating magnetic field for capture by a receiver resonator of receiver 210. In a bidirectional embodiment, each charger 206 can include a bidirectional resonator configured to transmit an oscillating magnetic field to a receiver 210 and capture an oscillating magnetic field generated by the receiver 210, and each receiver 210 can include a bidirectional resonator configured to capture an oscillating magnetic field from a charger 206 and transmit an oscillating magnetic field to a charger 206.

A charger operator 204 interested in making a charger 206 available for charging another person's vehicle may open an account with the service. An account can be created for a charger operator 204 and include characteristics related to that charger 206 such as:
location of the charger;
residential or commercial status;
availability of the charger (dates and times, and/or market price that the charger is available);
opt-in or opt-out of service negotiated reservations
opt-in or opt-out of reservation-less charging
charging rate;
power level (the power levels at which the charger can transmit power); and/or
type of charger and interoperability (which receiver the charger can deliver power to);
brand/model/serial number;
pricing scheme (fixed price, cost-plus, dynamic, market tied, surge-pricing);
preferred payment method;
charger ID;
sustainability rating (efficiency, sustainably sourced mains power);
bidirectional capability;

In embodiments, charger ID can be verified by online or offline means before the charger can be public to the network, and/or before they can be associated with the charger operator account. In embodiments, the charger characteristics can be updated to the central server when a characteristic is changed (for example by the charger operator, or by the charger). The update can be instantaneous, the next time the charger is online, periodic, or by request from the central server.

A vehicle operator 208 interested in using another person's charger can open an account with the service. An account can be created for a vehicle operator 208 and can include characteristics of the vehicle receiver 210 such as:
range per kwh;
vehicle ID;
vehicle receiver ID;
bidirectional capability;
opt-in or opt-out of service negotiated reservations (the service negotiates the price in vehicle operator's favor)
availability of the bidirectional receiver to supply power to the grid (dates, times, capacity or state of charge that the receiver is available and/or market price plus fees for the receiver to be made available)
power level (the power levels at which the receiver can receive or transmit power); and/or
type of receiver and interoperability (which chargers the receiver can receive power from).

In embodiments, a vehicle ID and vehicle receiver ID can be verified before they can be active on the network, and/or before they can be associated with the vehicle operator account. In embodiments, the vehicle receiver characteristics can be updated to the central server when a characteristic is changed, for example by the vehicle receiver operator, or by the vehicle or the vehicle receiver.

In addition to the technical details collected for the charger and receiver, details specific to the owners and/or operators of each can also be collected:
security credentials (e.g. online or offline identity)
verification of security credentials (if security credentials have been verified)
biographical information (e.g. first name, last name, date of birth)
pricing information (for charger operators, fee for providing a charger; and/or pricing scheme, and for vehicle operators an upper bound price or cost of using a charger, or fee/price for supplying power to the grid if the receiver on their vehicle is bidirectional);
favorability rating (for charger operators, ratings by vehicle operators that have used their chargers and for vehicle operators, ratings by charger operators that have provided their chargers to that vehicle operator);
opt-in/opt-out to service negotiated reservations (i.e. service negotiates price in vehicle operator's favor);
opt-in/opt-out to reservation-less use of chargers;
funds link (for example, for charger operators, a link to a deposit account, wallet address, or 3^{rd} party financial/transactional service such as PayPal® and for vehicle operators, a link to a credit card, wallet address, or 3^{rd} party financial/transactional service such as PayPal®);
contact information;
for vehicle operators, services requested;
for charger operators, services available that the vehicle operators can request, such as valet service to pick up or drop off the vehicle; ability to move the car after charging; extended and/or overnight parking options; ability to verify foreign object detection (FOD) events during charging;
personal preferences; and/or
personal requirements (such as keys to be left with the charger operators).

In embodiments, identity and/or security credentials can be verified before the accounts become public to the network.

In embodiments, the central server 202 can be communicatively coupled to each of the charger operators 204, vehicle operator 208, charger 206, receiver 210, and grid 207. For example, the central server 202 can communicate with the charger operators 204 and vehicle operator 208 via a web portal or application on a computer or mobile device (such a laptop, tablet, smartphone, smartwatch, in-vehicle console). The central server 202 can communicate with the charger 206 via a wireless communication channel such as WiFi at the place of installation (such as the garage or driveway of a residence). The central server 202 can be configured to communicate with the vehicle receiver 210 via a wireless communication channel The wireless communication channel can be WiFi when the vehicle receiver is within WiFi range. The wireless communication channel can be a direct communication channel to the vehicle receiver such as a cellular or satellite data connection. The grid 207 can be communicatively coupled directly with the central server 202, for example via wireless or wired communication, or via the charger 206 and the charger 206 and central server 202 communication path. For example, the grid 207 can communicate to the central server the market price of electricity, requests for more power to be supplied to the grid, or requests or demands for less power to be drawn from the grid. The market price, service provided fees, and requests can be pushed to chargers, receivers, charger operator, vehicles, and vehicle operators on the network 200 by the central server.

In embodiments, the charger operator 204 can communicate directly with their charger 206 via WiFi. This allows the charger operator 204 to have control over the operation of their charger 206. For example, the charger operator 204 can override any instructions sent by the central server 202 to the charger 206. Further, the charger operator 204 can communicate with any parts of the network via an application on their mobile device.

In embodiments, the vehicle operator 208 can communicate directly with their vehicle receiver 210. This communication may be through the vehicle itself or a direct communication channel to the receiver 210. For example, the vehicle operator 208 can override any instructions sent by the central server 202 to the receiver 210. In embodiments, the vehicle can control the receiver and all or most communication may be through the vehicle. In embodiments, the vehicle may have an operator interface, for example, located in the console that allows the vehicle operator to communicate with any parts of the network and/or control power transfer or reception. This can be in the form of an application on a digital or computer display or physical buttons built into the console. Further, the vehicle operator 208 can communicate with any parts of the network via an application on their mobile device. The operator interface for an autonomous vehicle controller operating the vehicle may be input and outputs with an interface of the vehicle controller.

In embodiments, the charger 206 can communicate directly with the vehicle receiver 210. This may be easily done for chargers and receivers of the same type or that are designed to be interoperable. Interoperability may be determined via standardization organizations, such as SAE (Society of Automotive Engineers), IEEE (Institute of Electrical and Electronics Engineers), International Electrotechnical Commission (IEC) or others. In embodiments, the vehicle (to which the receiver is attached) can control the receiver and all or most communication with the charger 206 may be through the vehicle. For example, the charger 206 and vehicle receiver 210 can communicate directly to perform verification, authentication, authorization, and/or a handshake protocol (see Transaction Embodiments).

In embodiments, the charger operator 204 and vehicle operator 208 can communicate directly. This communication channel may be available or allowed by the service once the vehicle operator 208 reserves the charger 206 for use for a specific duration. At this point, a communication channel may be permitted between the vehicle operator 208 and charger operator 204 in the case of emergency or extraneous situations (opening a garage door, entering a gated community, late arrival for vehicle pick-up, etc.). For example, the charger operator can provide a passcode for the garage door of the garage housing the charger. In some embodiments, information for the vehicle operator to access the charger are provided by the central server. In embodiments, certain issues such as those related to financial transactions, disputes, technical difficulties, etc. may be dealt at the level of the service operator (i.e. the central server) instead of between the charger operator 204 and vehicle operator 208. In embodiments, the path of communication may be through the path with the fewest nodes or processing. In other embodiments, all or most communication can be processed through the central server 202.

### Transaction Embodiments

In embodiments, the charger operator 204 can be financially incentivized by earning money for making available their charger 206. For example, the cost for a vehicle to charge at a particular charger 206 may be the cost of electricity (at that location) to be eventually paid to the utility provider and the service fee to be paid to the charger operator 204. In some embodiments, an additional fee from the vehicle operator 208 may be collected by the service itself. The fee paid to the charger operator 204 may be set by the charger operator or by the service. In embodiments, the fee paid to the charger operator 204 and/or service may be commensurate with the demand for the particular charger 206 or demand for a charger in that particular area. For example, if a particular charger 206 associated with the charger operator 204 is located in a high traffic location (such as near densely populated areas or conference centers), then the fee paid to the charger operator and/or service may be higher. In another example, if the demand for chargers is high and the supply low, then the fee paid to the charger operator and/or service may be higher. The service can advertise to chargers and/or charger operators that demand is high and the fee has increased. The service can ask charger operators with chargers that are not in use if they want to make their chargers available to the network, and provide a bounty for specific chargers to be made available. The service can negotiate the price of charging in the charger operator's favor by negotiating the price to a price that the charger operator would be willing to make their charger available. The service can ask vehicle operators to make available their usual chargers 106. If the charger operators have opted-in to service negotiated reservations. The above described schemes may also create incentive for the charger operator 204 to own more than one charger at their property or residence. For example, one of the chargers can be used by the charger operator's vehicle while a second or third charger can be used by customer of the service (the vehicle operator 208).

In embodiments, the vehicle operator 218 can be financially incentivized by earning money for making available their bidirectional vehicle receiver 210. For example, the cost for a vehicle to charge at a particular charger 206 may be the cost of electricity (at that location) to be eventually paid to the utility provider and the service fee to be paid to the charger operator 204. In some embodiments, an additional fee from the grid 207 may be collected by the service itself. The fee paid to the vehicle operator 208 may be set by the vehicle operator or by the service. In embodiments, the fee paid to the vehicle operator and/or service may be commensurate with the demand for the particular bidirectional vehicle receiver 210. For example, if a particular bidirectional vehicle receiver 220 associated with the vehicle operator 210 is located in a location at a time with high demand for power, then the fee for the vehicle to provide power, paid to the vehicle operator and/or service, may be higher. In another example, if the demand for power is high and the supply low, then the fee paid to the bidirectional vehicle operator and/or service may be higher.

The service can receive requests from the grid for more power to be supplied to the grid, or receive requests or demands for less power to be drawn from the grid. The service can push these requests or advertise to vehicle operators that demand is high and the fee for making their bidirectional receiver available to the grid has increased. The service can ask vehicle operators with vehicles having full or nearly full state of charge if they want to provide power to the grid and suggest they initiate a search for a charger, or suggest to them the nearest available chargers. The service can negotiate the price of charging with the grid in the vehicle operator's favor by negotiating the price to a price that the vehicle operator would be willing to provide power to the grid. The service can price charging differently based on energy supplied at tier levels of power. For example, high speed charging may be priced at a premium. The service may ask vehicles that are charging their vehicles to switch to a lower power level for charging their cars. The service may cease or lower power transmission for all or certain chargers providing power to vehicle receivers. The service may ask vehicles that are charging their vehicles to switch to bidirectional mode for providing power to the grid.

In embodiments, the service can use a digital asset, pseudo-currency, and/or credits based on the value of real currency for financial transactions and incentivizing various parties. For example, “charge-bucks” can be related to the value of US Dollars but may be fluid based on supply and demand. For example, the conversion between charge-bucks and US Dollars may change over time and locations. In another example, charging prices may be less expensive during the day in residential areas and more expensive in business/industrial areas. Charging prices may fluctuate with dynamic electric grid prices (time-of-use pricing, critical peak pricing, surge pricing, direct load control, and real-time pricing, according to a neighborhood average).

In another example, the charger operator 204 can opt to accept payment in the form of real currency or in the form of a digital asset (e.g. “charge-bucks”) that can be used for more amount of charging at another charger. In other words, there may be situations where the “charge-bucks” are worth more than the US Dollars for the use of the service. An example scenario may be:

Charger Operator A charges 5 US Dollars for the use of Charger A by Vehicle B.

Service gives option of accepting 5 US Dollars or 10 Charge-Bucks. Charger Operator A accepts 10 Charge-Bucks.

Charger Operator A can use the service to charge his/her Vehicle A at another Charger C and pay in Charge-Bucks.

By paying in Charge-Bucks instead of US Dollars, Charger Operator A can use Charger C for a longer time and/or for a discount.

In embodiments, the central server can receive information based on the energy supplied by (or to) the charger, the energy received by (or from) the vehicle receiver, or energy supplied by the grid or received from the grid In embodiments, the central server 202 may receive information about the cost of energy based on the location and/or ID of the charger 206, and/or from the grid 207 and reimburse the charger operator 204, vehicle operator 218, or pay the utility provider directly. In embodiments, the central server 202 may price charging differently or provide discounts based on a membership level of either the vehicle operator 208 or charger operator 204. For example, a vehicle operator 208 may gain a higher status membership with more frequent use of the service. Membership information may be linked to the unique ID of the vehicle operator's account and/or the vehicle receiver 210. In embodiments, the central server may price charging differently based on energy supplied at tier levels of power. For example, high speed charging may be priced at a premium. The service may offer rebates or discounts for “off-peak” charging, or for prompt removal of vehicles after charging. In embodiments, payment transactions may be initiated offline, between the charger and receiver, with the transaction completed or “settled” when there is connectivity with the central server.

In embodiments where the vehicle battery is supplying power to the grid 207, the vehicle operator's payment account may be credited. An example scenario may be:

Vehicle Operator B's account may be credited 10 “charge-bucks” after Vehicle Operator B uses Charger A to supply power to the grid during a “critical peak” event, wherein the price of electricity is increased by the grid compared to a baseline or “off-peak” time.

In embodiments, a handshake protocol may be used between the charger 206 and the receiver 210 to confirm any or all of the following:
that the vehicle and vehicle receiver 210 belongs to the vehicle operator's (208) account with the service;
that security credentials have been verified;
that the charger 206 and vehicle receiver 210 are compatible in terms of interoperability, power level, types, for example based on SAE, IEEE, IEC standards; and/or
that the charger 206 is the intended charger at the intended location for transmitting power to the vehicle receiver 210.

In embodiments, a handshake protocol may be used between the charger 206 and the vehicle receiver 210 to prepare the charger to begin transmission of power, by supplying to the charger from the receiver:
preferred charging setpoints (e.g. power, voltage)
auxiliary system settings.

In embodiments, the handshake protocol includes pairing and compatibility check protocols, for example, those by IEEE, SAE, IEC. The handshake protocol may be performed
as soon as a communication link is established by the charger and the vehicle receiver auxiliary system settings;
during alignment of the vehicle; and/or
after alignment and positioning of the vehicle.

In embodiments, the charger 206 and the vehicle receiver 210 each have unique identification information that may be checked and confirmed by the other (i.e. the charger ID checked by the receiver and vice versa) and/or the central server 202. In embodiments, each charger ID and vehicle receiver ID have associated information such as the model, brand, last associated account, whitelist status, blacklist status, availability information (for chargers), auxiliary system settings (such as for a positioning and alignment system(s) and/or FOD), preferred charging set-points and mode (battery voltage, charge rate, fast charge mode, battery-life extension mode), last associated vehicle ID (for the vehicle charger ID), preferred charger vehicle communication protocol, bidirectional charging compatibility.

In embodiments, the handshake protocol can be performed over any one of or combination of WiFi, Bluetooth, radio, RFID, GPS, cellular data, and the like. As an example, the GPS location of the vehicle receiver can be within a range of tolerance of the charger GPS location and/or the vehicle operator. In embodiments, handshake protocol is performed by the charger, the vehicle receiver, and/or the central server. In embodiments, the handshake protocol may be complemented with a verification pin communicated by the charger operator and vehicle operator, or through multiple factor authentication with the operators. In embodiments, private/public key pairs may be generated by the server, the charger, or the vehicle receiver. The public keys can be shared between the charger and vehicle receiver for authentication as part of or separate from the handshake protocol. The central server may receive confirmation of a successful or unsuccessful handshake protocol.

In embodiments, the charger receives the vehicle receiver ID (and associated information) from the server, and the charger adds the vehicle receiver ID to a local whitelist of allowed vehicle receivers for a defined period of time. In embodiments, the vehicle receiver receives the charger ID from the central server and stores the charger ID (and associated information) to a local whitelist. In embodiments, the central server 202 can update the firmware and/or software of a charger 206 or receiver 210. In embodiments, the charger can update the associated information of the charger ID to the central server and the vehicle receiver can update the associated information of the vehicle receiver ID to the central server. In embodiments, the central server 202 can update the firmware and/or software of a charger 206 or receiver 210. In embodiments, the central server 202 can update the whitelist/blacklist of a charger 206 or receiver 210. In embodiments, server administrators can update the central server, for example, the method for determining interoperability or compatibility.

In embodiments, once the vehicle battery is full or nearly full, power transmission can cease. Power transmission can be interrupted or stopped by either of the charger 206, the vehicle operator, the charger operator, or vehicle receiver 210. A vehicle operator 208 may wish to leave a charging location earlier than planned. In some embodiments, the vehicle operator or charger operator may be notified by the central server to end charging at a particular charger if that charger is determined to be in high demand. Subsequently, the vehicle operator can signal to the charger to end transmission. For example, there may be limits on charging durations for particularly busy chargers. In embodiments, the operator can be charged a penalty if they do not remove the vehicle, for example, when the charging is complete or after an agreed-upon duration of charging. In embodiments, the charger operator may move the vehicle for a fee. For example, the charger operator may make the charger available for a certain number of hours, after which the operator can be obligated to remove their vehicle from the charger or face a penalty. The penalty can be monetary or punitive, such as temporarily or permanently deactivating the account of the operator such that they cannot seek chargers via the service associated with the central server, temporarily blacklisting the vehicle receiver ID, or the account of the operator may receive a lower favorability rating. In other examples, if the vehicle operator has not moved the vehicle after a defined period of time, the charger operator may move the vehicle to an adjacent parking spot with or without approval from the vehicle operator, personally, or with a vehicle extraction robot.

In embodiments, various algorithms may be used and filters applied, to match a vehicle receiver 210 with a charger 206. The matching may be based on any of the above options given above for the charger operator's and/or vehicle operator's accounts. The matching may be based on a hierarchical list created based on charger characteristics and at least one operator preference or personal requirement. The charger characteristics can be saved in a database in the central server. For example, chargers in the vicinity of the vehicle may be ranked and/or selected by the central server 202 based on charger characteristics and vehicle operator personal preferences or requirements, such as the availability of charger at a defined period of time, power level(s), brands, favorability rating, security credentials; bidirectional functionality, interoperability, price (specific or range of prices) and/or fees, sustainability rating, etc. Additionally, the matching may be based on the location of the vehicle as it travels or is parked. For example, as the vehicle travels around a neighborhood, an algorithm may be routinely determining the closest distance charger to the vehicle. In another example, the closest distance charger to a planned destination may be selected. In the scenario shown in FIG. 1, the vehicle is closer in distance to charger 108 compared to charger 110. This may be determined with the use of GPS, cellular data, coupling information, and/or WiFi capabilities, on the central server or on the vehicle. The matching may be based on lowest priced charger. The selection of the charger for reservation may be completed by the central server, or with input from the vehicle operator, or the vehicle. In embodiments, details related to the reservation may be communicated to the charger, charger operator, the vehicle operator, and/or the vehicle. In embodiments, reservation reminders and/or confirmations, may be communicated.

FIG. 2B shows a diagram of an exemplary embodiment of a network 212 for a service as described above. The network 212 includes a central server 202 connected to the vehicle charger 206 and vehicle receiver 210. Connected to the central server 202 is a charger operator account 214, which is itself accessed and/or controlled by the charger operator 204. The charger operator 204 can also access and/or control the vehicle charger 206. The central server 202 can be connected to an operator account 216, which is itself accessed and/or controlled by a vehicle operator vehicle 218. The vehicle receiver 210 is connected to the vehicle 220. The operator 218 has access and/or control over the vehicle 220. The charger 206 can be connected to the grid 207 and either the charger 206 or receiver 210 can be bidirectional.

In embodiments, a “vehicle operator account” 216 can be associated with an operator 218 so that the operator may use multiple vehicles with their vehicle operator account. Consider the following example: the operator may own a vehicle (vehicle A) that is used daily for work or school. Using their vehicle operator account, the operator can seek chargers for vehicle A near their work or school. Using the same vehicle operator account, the operator can seek chargers for vehicle B that may be rented in a vacation or business destination. Thus, the vehicle operator account may be associated with one or more vehicles at a given time. In embodiments, the vehicle receiver may communicate with the central server to be associated with a particular vehicle operator account. In the rental scenario, the operator may disassociate the vehicle B once the rental is over (so that their operator account is not accountable for charges made by another rentee/operator). In some embodiments, the operator may preset the amount of time vehicle B is associated with the vehicle operator account and the central server can disassociate the account with vehicle B at the prescribed time.

Further, the operator may authorize additional operators to use the same account to be able to borrow their vehicle via the same vehicle operator account. In another embodiment, multiple vehicles may be associated with a vehicle operator account such that the transactions for a set of vehicles are associated with the same account. This may be useful for a family with multiple vehicles or a business owner with multiple vehicles.

In embodiments, the vehicle operator account can link to a subscription service, such as a one-time, daily, weekly, monthly, and/or yearly service to be able to search and use chargers in the service. In embodiments, the account can provide the operator a report on usage, cost, etc. on, for example, a monthly basis. There may be alerts in connection with the account and/or in connection with a specific transaction or reservation, including billing and transactional status, charge status, estimate to charge completion, charge complete, state of charge, time to charge complete, time to a defined state of charge, surge pricing or critical peak pricing alerts, amount of range available based on charge status, and the like. The vehicle operator account may be billed periodically or after each transaction.

### Example Embodiment

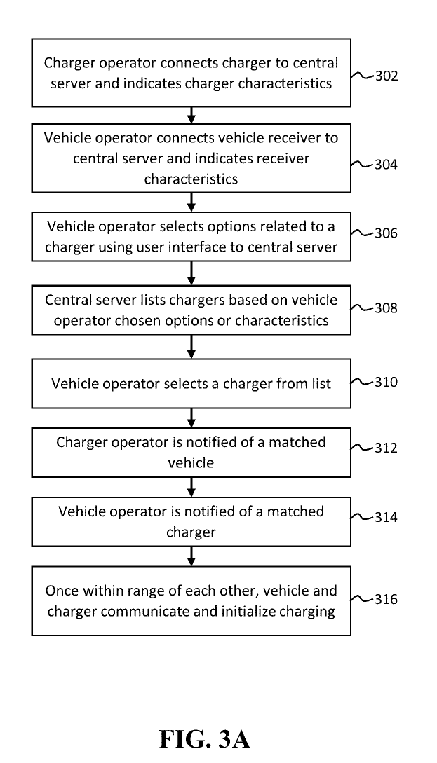

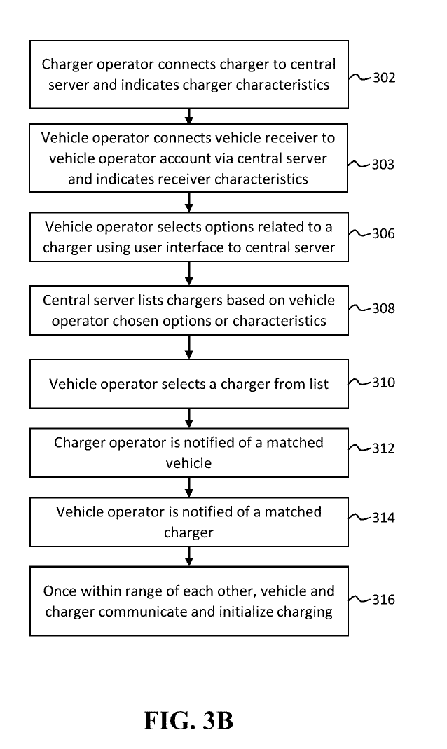

FIG. 3A shows a flowchart of an example embodiment of matching a vehicle receiver 210 with a vehicle charger 206. In step 302, the charger operator 204 connects charger 206 to a central server 202 and indicates charger characteristics (see listed above). In step 304, the vehicle operator 208 connects vehicle receiver 210 to the central server 202 and indicates receiver characteristics. In step 306, vehicle operator 208 selects options related to a charger using an operator interface to central server 202. In embodiments, the vehicle operator's preferred options, default options, and/or last used options, may be preselected and shown on the operator interface for the operator. In step 308, central server lists chargers based on vehicle operator's chosen preferences and/or charger characteristics (see section “Networks”). In embodiments, the central server lists chargers based on compatibility, and/or interoperability between the receiver and available chargers, in addition to the vehicle operator's chosen options or characteristics. Compatibility can be determined algorithmically using factors such as interoperability and the status of previous charging sessions. The contributing factors to a compatibility algorithm can be updated to the central server by an administrator, by a machine learning algorithm or by training The benefit to this approach is the vehicle operator not arriving to the available and preferred charger only to see that the charger and the vehicle receiver are not compatible.

In step 310, vehicle operator 208 selects a charger from the hierarchical list. In step 312, charger operator 204 is notified of a matched vehicle and in step 314, vehicle operator 208 is notified of a matched charger. In step 316, once the vehicle is within a range of the charger, the vehicle receiver can communicate with the charger (for example, to perform the handshake protocol), and initialize charging of the vehicle. In embodiments, the handshake and initialization of charging is prompted by the central server 202. Alternatively, in a bidirectional embodiment, once the vehicle is aligned with the charger, the receiver can supply energy to the charger, which can be returned to the grid or stored locally (e.g., by a local battery) for later use by the operator of the charger. In some embodiments, the range can be determined by the coupling factor between a transmitter resonator and receiver resonator of a wireless power transmission system (i.e. the higher the coupling or within a specific range). In some embodiments, the range for communication can be determined by a WiFi signal that is picked up by the receiver and/or vehicle. In some embodiments, the range can be determined by GPS or a combination of WiFi, cellular, coupling factor, positioning and alignment system, or GPS.

FIG. 3B shows a flowchart of an example embodiment of matching a vehicle receiver 210 with a vehicle charger 206. In step 302, the charger operator 204 connects charger 206 to a central server 202 and indicates charger characteristics (see listed above). In step 303, the vehicle operator 208 connects vehicle receiver 210 to an operator account 216 the central server 202 via the central server 202 and indicates receiver characteristics. In step 306, vehicle operator 208 selects options related to a charger using a user interface to central server 202. In step 308, central server lists chargers based on vehicle operator's chosen options or characteristics (see section “Networks”). In embodiments, the central server lists chargers based on interoperability between the receiver and available chargers, in addition to the vehicle operator's chosen options or characteristics. In step 310, vehicle operator 208 selects a charger from the list through a user interface. In addition, or alternatively to a list, the location of available chargers may be positioned on a map on the user interface, and the vehicle operator's may select a charger from the map. In step 312, charger operator 204 is notified of a matched vehicle and in step 314, vehicle operator 208 is notified of a matched charger. In embodiments, the charger operator may opt out of notifications 314, but the charger is automatically reserved and confirmed based on availability on the schedule. In embodiments, the charger operator may have a certain window of time to approve or reject the match, otherwise the match is approved or rejected by the central server. In step 316, once the vehicle is within a range of the charger, the vehicle receiver can communicate with the charger (for example to perform the handshake protocol) and initialize charging of the vehicle. In embodiments, the handshake and initialization of charging is prompted by the central server 202. Alternatively, in a bidirectional embodiment, once the vehicle is aligned with the charger, the receiver can supply energy to the charger, which can be returned to the grid or stored locally (e.g., by a local battery) for later use by the operator of the charger.

In embodiments, the charger can stop, decrease, or increase transmitting power to the vehicle receiver based on one or more of the following scenarios:
The load or battery of the vehicle may be fully charged. In this case, a battery manager of the vehicle can communicate with the receiver to indicate a “fully charged” status.
The load or battery of the vehicle may be nearly charged (e.g., 80%, 85%, 90%, 95%, 96%, 97%, 98% or 99% state of charge). In this case, a battery manager of the vehicle can communicate with the receiver (which can then communicate with the charger) to decrease or cease power transmission.
The receiver can communicate with the charger or with the central server (which can then communicate with the charger) to cease power transmission.
The vehicle receiver can sense an error condition and communicate with either the charger or the central server 202 to cease or decrease power transmission.
The vehicle operator can choose to end power transmission by indicating on an operator interface to the central server 202. Alternatively, the vehicle operator can turn on the vehicle and/or pull away at which time the charger can detect that power transmission can be shut off
The charger operator can choose to end power transmission if necessary, for example, if there is a breach of security or other undesirable situation. The charger operator can indicate on the user interface (that can be customized for the charger operator) to cease power transmission. In bidirectional embodiments, the bidirectional vehicle receiver can stop, decrease, or increase transmitting power to the charger based on one or more of the following scenarios:
The load or battery of the vehicle may be fully depleted. In this case, a battery manager of the vehicle can communicate with the receiver to indicate a “fully depleted” status.
The load or battery of the vehicle may be nearly depleted (e.g. 35%, 30%, 25%, 20%, 19%, 15%, 10%, or 5% state of charge). In this case, a battery manager of the vehicle can communicate with the receiver (which can then communicate with the charger) to cease power transmission.
The load or battery of the vehicle may be in a state of charge where the vehicle only has sufficient energy to return the vehicle to its home base.
A local battery may achieve a full or nearly full (e.g., 80%, 85%, 90%, 95%, 96%, 97%,98%, or 99%) state of charge.
The bidirectional vehicle receiver can sense an error condition and decrease power transmission.
The vehicle operator can choose to end power transmission by indicating on an operator interface to the central server 202. Alternatively, the vehicle operator can turn on the vehicle and/or pull away at which time the vehicle or charger can detect that power transmission can be shut off
The vehicle operator or charger operator can choose to end or interrupt power transmission based on a breach of security or other undesirable situation. The charger operator can indicate on the user interface (that can be customized for the charger operator) to cease power transmission.

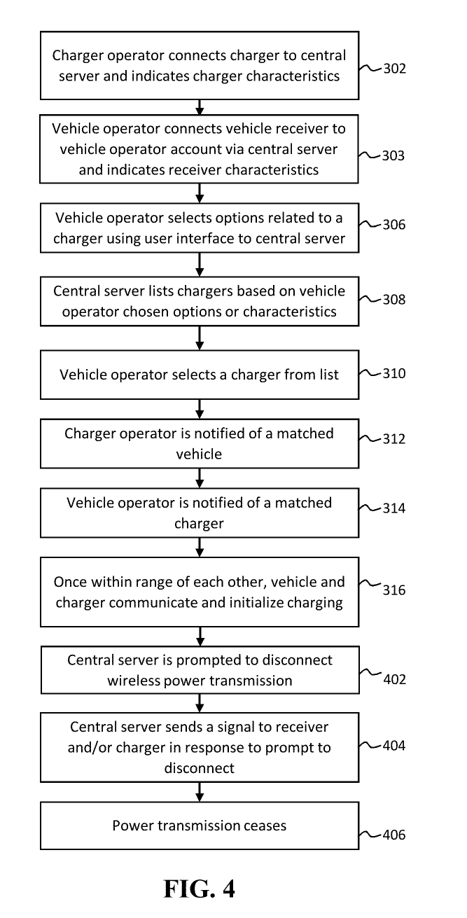

FIG. 4 shows a flowchart of an exemplary embodiment of controlling power transmission from a vehicle charger 206 to a vehicle receiver 210. Once steps 302 to 316 have taken place (see description above for FIG. 3B), the central server may be prompted by any one or more of the above listed scenarios or can be otherwise prompted to disconnect (in step 402). In step 404, the central server, the vehicle operator, the charger operator, the battery manager, can signal to the charger 206 to cease power transmission or can signal to the vehicle receiver 210 to stop receiving power. The vehicle receiver 210 can open, disconnect, or switch in, one or more parts of the circuit to stop receiving power. The charger 206 can open, disconnect, or switch in one or more parts of the circuit to stop transmitting power. In step 406, power transmission ceases. The charger or vehicle receiver can signal to the central server that power transmission has ended. The energy transferred can be reported to the central server for payment processing/billing.

In embodiments, when a bidirectional receiver 210 is providing power to the grid or to a local battery via a bidirectional charger 206, the central server may be prompted by the vehicle operator, the charger operator or the battery manager, to stop power transmission 404. For example, if the price of energy decreases (e.g., by more than 5%, more than 10%, more than 15%, or more than 20%), the central server can communicate to the bidirectional vehicle receiver to cease power transmission 404. In another embodiment, power transmission 404 can be stopped if the local battery achieves a full or nearly full state of charge. The bidirectional receiver 210 can open, disconnect or switch in one or more parts of the circuit to stop transmitting power. The bidirectional charger 206 can open, disconnect or switch in one or more parts of the circuit to stop receiving power. The energy transferred can be reported to the central server for payment processing/billing.

### Additional Embodiments

In embodiments, one set of charger power and control electronics can be used to supply and control power to more than one source resonators. Charger power and control electronics may include power factor controller, inverter, amplifier. For example, a charger operator 204 may purchase a first set of electronics to supply power to a first source resonator. The charger operator 204 may purchase a second source resonator to couple to the first set of electronics. These first set of electronics may provide power to the first and second source resonators simultaneously or alternatively. For example, the power provided to each of the source resonators may be multiplexed in time. As another example, the power provided to each of the source resonators may be managed dynamically according to either of priority, expected charge time, or to complete charging at the same time. In some embodiments, the purchase of the second source resonator may be an incremental expense compared to the first set of electronics plus first source resonator. The first set of electronics can communicate with the central server 202. The first set of electronics can power each of the resonators based on power draw or priority given to one of the vehicles. For example, the power draw may be different for each of the vehicles' batteries in a vehicle positioned over either of the two or more source resonators. Further, the first set of electronics can prioritize based on whether one of the vehicles is owned (or not) by the charger operator 204, belonging to a premium or subscription service.

In embodiments, autonomous vehicles may communicate directly with the central server 202 or chargers to locate a charger at a present time or to make a reservation for a future time. The autonomous vehicle can initiate a search for a charger when the state of charge is below a threshold, when the demand for transportation with the vehicle is low, and/or when the price of electricity is below a threshold. The autonomous vehicle can make a reservation for future charging session based on its predicted future state of charge. The autonomous vehicle can initiate a search for a bidirectional charger to supply power to the grid when the state of charge is above a threshold, when a request is made by the grid, when the demand for transportation with the vehicle is low, and/or when the price of electricity is above (or planned to be above) a threshold. In embodiments, two or more autonomous vehicles may be able to share a single charger by repositioning themselves after a vehicle is finished charging or a time allotted to one of the vehicles is over. For example, a first autonomous vehicle can finish charging and pull away from a charger to make room for a second autonomous vehicle to start charging. The central server 202 may be configured to manage or schedule this process for multiple chargers. In other embodiments, the first set of electronics may be configured to manage and/or schedule this process for multiple source resonators. In embodiments, the central server 202 can be connected to other devices, such as those controlling garage doors or entryways so that human intervention is not needed to allow the vehicle to reach a charger. In embodiments, some or all of the vehicle charging processes described herein for autonomous vehicles can be performed without human intervention.

In embodiments, the charger operator can opt-in to reservation-less charging. A vehicle operator can drive-up, authenticate, charge, and the service can handle the payment transaction and the availability of the charger is updated by the service or charger in the central database for the duration of the charging session. Charging can only starts after a successful authorization. For example, vehicle operator can use a charger 135 in the road 132, a charger 115 in a parking lot 117, or a charger 110 at a commercial facility 111 without making a reservation. The service recognizes the vehicle, determines authorization, updates the charger availability in the central database, starts charging, when charging ceases (for example by the vehicle operator through the central server), the service determines a cost for the charging, and completes the payment transaction.

In embodiments, the network can be increased in size by each vehicle operator making available their charger and each charger operator using another charger in the network for their vehicle. In some embodiments, the network may be contained to charger and vehicle operators that provide or use the reciprocal service.

The “central server” may be at one site or be distributed across multiple sites interconnected by a communication network.

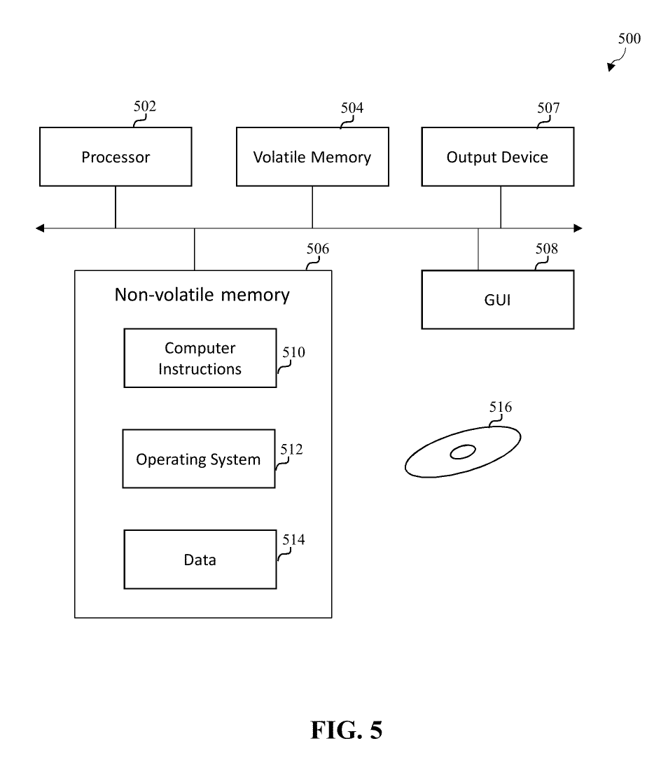

FIG. 5 shows an example computer 500 that can perform at least part of the processing described herein. The computer 500 includes a processor 502, a volatile memory 504, a non-volatile memory 506 (e.g., hard disk), an output device 507 and a graphical user interface (GUI) 505 (e.g., a mouse, a keyboard, a display, operator interface, for example). The non-volatile memory 506 stores computer instructions 510, an operating system 512 and data 514. In one example, the computer instructions 510 are executed by the processor 502 out of volatile memory 504. In one embodiment, an article 516 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

While the disclosed techniques have been described in connection with certain preferred embodiments, other embodiments will be understood by one of ordinary skill in the art and are intended to fall within the scope of this disclosure. For example, designs, methods, configurations of components, etc. related to transmitting wireless power have been described above along with various specific applications and examples thereof. Those skilled in the art will appreciate where the designs, components, configurations or components described herein can be used in combination, or interchangeably, and that the above description does not limit such interchangeability or combination of components to only that which is described herein.

All documents referenced herein are hereby incorporated by reference.

What is claimed is:

1. A computer implemented method comprising:
receiving, by a computing device, first information indicative of an availability of multiple chargers;
receiving, by the computing device, a request for a list of available chargers from an operator of a vehicle;
creating, by the computing device, a hierarchical list of available chargers based on the first information and at least one operator preference, the hierarchical list delivered to an operator interface; and
receiving, by the computing device, second information indicative of an operator selection of at least one charger from the hierarchical list.

2. The computer implemented method of claim 1 further comprising receiving, by the computing device, a third information indicative of a receiver of the vehicle positioned to receive power from the at least one charger.

3. The computer implemented method of claim 2 further comprising signaling, by the computing device, to the at least one charger to initiate power transmission to the receiver.

4. The computer implemented method of claim 3 further comprising:
receiving, by the computing device, fourth information indicative of the operator ceasing use of the charger; and
determining, by the computing device, cost of charging based on characteristics of the charger and length of use of the charger.

5. The computer implemented method of claim 4 further comprising transmitting, by the computing device, a receipt including the cost for the charging session to the operator interface.

6. The computer implemented method of claim 5 further comprising applying the cost to an account of the operator.

7. The computer implemented method of claim 2 further comprising transmitting the third information to the at least one charger, wherein the third information comprises a receiver ID corresponding to the receiver, and wherein the receiver ID is identifiable by the charger.

8. The computer implemented method of claim 7 further comprising receiving, by the computing device, a charger ID, wherein the charger ID and receiver ID are used in a handshake protocol between one of the at least one chargers and the receiver.

9. The computer implemented method of claim 1 further comprising subtracting a first amount related to a cost of charging from an account of the operator and adding a second amount to an account of a charger operator.

10. The computer implemented method of claim 9 wherein the second amount is larger than the first amount.

11. The computer implemented method of claim 9 wherein at least one of the first or second amounts is a digital asset.

12. The computer implemented method of claim 1 wherein each charger comprises a transmitter resonator configured to generate an oscillating magnetic field for capture by a receiver resonator of a receiver of the vehicle.

13. The computer implemented method of claim 1 wherein a receiver of the vehicle comprises a bidirectional resonator configured to transmit an oscillating magnetic field and capture an oscillating magnetic field.

14. The computer implemented method of claim 1 wherein the operator interface is an interface of a mobile device or a vehicle.

15. The computer implemented method of claim 1 wherein the at least one operator preference is at least one of a power level(s), a brand, an interoperability standard, a price range, a favorability rating, and a bidirectional functionality.

16. The computer implemented method of claim 1 wherein the first information is indicative of an availability and interoperability of multiple chargers.

17. The computer implemented method of claim 1 further comprising performing, by the computing device, a handshake protocol between the charger and a receiver of the vehicle, wherein the handshake protocol confirms at least one of the receiver belongs to an account of the vehicle operator or the charger is the intended charger at the intended location for transmitting power to the receiver.

18. The computer implemented method of claim 1 wherein the availability of multiple chargers is indicative of at least one of the dates, times and price that the charger is available.

19. The computer implemented method of claim 1 further including creating a reservation based on the operator selection and the operator preference, the reservation delivered to the operator interface.

20. The computer implemented method of claim 1 wherein the operator is a vehicle driver.

21. The computer implemented method of claim 1 wherein the operator is an autonomous vehicle controller.

22. A computer program product, tangibly embodied in a machine-readable storage device, the computer program product including instructions being operable to cause a data processing apparatus to:
receive first information indicative of the availability of multiple chargers;
receive an operator request for a list of available chargers;
create a hierarchical list of available chargers based on the first information and at least one operator preference, the hierarchical list delivered to an operator interface; and
receive second information indicative of an operator selection of at least one charger from the hierarchical list.

23. The computer program product of claim 22 including instructions being operable to cause a data processing apparatus to:
receive third information indicative of the operator ceasing use of the charger; and
determine cost of charging based on characteristics of the charger and length of use of the charger.

24. A computer device, including a computer processor system, the computer device configured to:
receive first information indicative of the availability of multiple chargers;
receive a request from a vehicle operator, for a list of available chargers;
create a hierarchical list of available chargers based on the first information and at least one operator preference, the hierarchical list delivered to an operator interface; and
receive second information indicative of an operator selection of at least one charger from the hierarchical list.

25. The computer device of claim 24 configured to:
receive third information indicative of the operator ceasing use of the charger; and
determine cost of charging based on characteristics of the charger and length of use of the charger.
